(19) United States
(12) Patent Application Publication
(10) Pub. No.: US 2015/0088635 A1
(43) Pub. Date: Mar. 26, 2015

(54) SYSTEMS AND METHODS OF MEASUREMENT AND MODIFICATION OF ADVERTISEMENTS AND CONTENT

(71) Applicant: Umbel Corporation, Austin, TX (US)

(72) Inventors: Higinio O. Maycotte, Austin, TX (US); Rishi Shah, Austin, TX (US); Megan Winget, Austin, TX (US); Troy Lanier, Austin, TX (US); Michael Baird, Austin, TX (US); Travis Turner, Austin, TX (US); Cody Soyland, Austin, TX (US)

(21) Appl. No.: 14/494,293

(22) Filed: Sep. 23, 2014

Related U.S. Application Data
(60) Provisional application No. 61/881,263, filed on Sep. 23, 2013.

(51) Int. Cl. G06Q 30/02

(52) U.S. Cl. CPC G06Q 30/0244; G06Q 30/0251
USPC 705/14.43; 705/14.49

(57) ABSTRACT

Systems and methods of measurement and modification of advertisements and content are described. In one example, advertisements/content items (or web servers or applications that present the advertisements/content items) send signals to a measurement server in response to certain events or actions. The signals identify the advertisement/content item and the user that caused the event or performed the action. The measurement server aggregates received signals from different advertisements/content items to determine metrics such as digital brand lift (e.g., a change in brand awareness due to an advertisement/advertising campaign). The measurement server can send computed information back to an advertisement/content item, so that the advertisement/content item (or web server/application) can self-modify and/or deploy additional advertisements/content items.

### CROSS-REFERENCE TO RELATED APPLICATIONS

The present application claims priority from U.S. Provisional Patent Application No. 61/881,263 filed on Sep. 23, 2013 and entitled “SYSTEMS AND METHODS OF MEASUREMENT AND MODIFICATION OF ADVERTISEMENTS AND CONTENT,” the contents of which are expressly incorporated by reference in their entirety.

### BACKGROUND

Premium brand advertising is one type of advertising. Premium brand advertising focuses on how an advertisement or advertising campaign changes the perception of a brand within an audience. Thus, in premium brand advertising, a “successful” advertisement may be one that changes a person's mind, not necessarily one that results in a sale of a good or service. A luxury car company, for example, may advertise its energy efficient cars to young consumers who lack the buying power to immediately purchase a luxury car in the hope that they remember the luxury brand when upgrading to a luxury car in the future. Before the advent of the Internet, premium brand advertising was typically conveyed via television, radio, and print media, and was typically measured via surveys. For example, a set of people exposed to an advertisement and a set of people not exposed to the advertisement may be surveyed regarding whether their perception of an advertised brand has changed. Similarly, content was measured by having readers fill out surveys and mail the surveys back to content publishers that used the surveys to improve content quality and style.

With the advent of the Internet, and the increasing popularity of Internet-based media content, advertising methods have changed. Instead of measuring changes in a user's perception, Internet-based advertising measurement systems focus on quantitative metrics—how many people saw an advertisement, how many people clicked on an advertisement, etc. Such quantitative metrics lend themselves to direct response advertising, or advertising that encourages an immediate sale, not premium brand advertising. Thus, direct response advertising makes up most of the advertising on the Internet. Further, quantitative metrics of content (e.g., time on a website, reading depth on a web page, etc.) may be used to estimate how much a consumer enjoyed the content.

### SUMMARY

As traditional mediums such as television, radio, and print become less popular, the premium brand advertising market may migrate towards the Internet. The present disclosure describes systems and methods of implementing premium brand advertising in Internet-based channels and mobile channels. Advantageously, the described systems and methods operate automatically, without requiring users to fill out cumbersome surveys. Alternately, survey data may be used as one type of input signal in the described systems and methods.

In one example, the described techniques enable measurement of digital brand lift. Digital brand lift may be a metric that provides advertisers actionable information regarding how well an advertisement or an advertising campaign is performing. Performance of the advertisement or advertising campaign may be measured in various ways, including but not limited to viewability, interactions, campaign goals, engagement with the advertisement (e.g., clicking on the advertisement), engagement with the advertised brand (e.g., “liking” or mentioning the brand on a social network platform), etc.

The described techniques may involve the use of an “intelligent advertisement.” For example, an advertisement may be instrumented or “wrapped” with software that causes the advertisement to communicate signals to an advertising measurement system. The signals may be event-based, and may include events corresponding to when the advertisement is downloaded by a device, when the advertisement is viewed by a user, when the advertisement is clicked on by the user, etc. The advertising measurement system may receive signals from multiple advertisements across multiple properties (e.g., websites). The advertising measurement system may determine metrics such as digital brand lift and other premium brand advertising metrics based on the received signals.

Advantageously, the advertising measurement system may also receive signals regarding individual users that interacted with the advertisement. For example, the advertising measurement system may receive (or retrieve) information from social network profiles of the users. By correlating and comparing signals received from the advertisements to other signals, the advertisement measurement system may be able to determine advanced metrics such as how digital brand lift evolves before, during, and after an advertising campaign. As another example, the system may determine how a particular advertising campaign is performing with respect to a competitor. To illustrate, the described techniques may enable determining whether and how much an advertising campaign for product A resulted in digital brand lift in people who have an affinity for competing product B.

The measurement system may also receive signals regarding individual users who interact with a particular piece of content. The signals may be event-based, and may include events corresponding to when the content is downloaded by a device, when the content is viewed by a user, when the content is clicked on by the user, etc. The measurement system may receive signals regarding multiple pieces of content across multiple properties (e.g., websites). The measurement system may determine metrics, such reader quality and author score, which may determine how well an audience is engaging with content written by a particular author or about a specific topic.

### BRIEF DESCRIPTION OF THE DRAWINGS

FIG. 1 is a diagram to illustrate a particular embodiment of a system that is operable to support measurement and modification of advertisements and content;

FIG. 2 is a diagram to illustrate another particular embodiment of a system that is operable to support measurement and modification of advertisements and content;

FIG. 3 is a diagram to illustrate data flow in the system of FIG. 2;

FIG. 4 is a diagram to illustrate an example of using received signals to compute metric(s) within a federated property;

FIG. 5 depicts graphs to illustrate computed brand lift based on the signals of FIG. 4;

FIG. 6 is a diagram to illustrate an example of using received signals to compute metric(s) within a measurement universe;

FIG. 7 depicts graphs to illustrate computed brand lift based on the signals of FIG. 6;

FIG. 8 is a diagram to illustrate an example of using received signals to compute metric(s) within an opt-in network that includes unrelated properties;

FIG. 9 depicts graphs to illustrate computed brand lift based on the signals of FIG. 8;

FIG. 10 is a screenshot to illustrate a particular embodiment of a grid report of multiple advertising campaigns;

FIG. 11 is a screenshot to illustrate a particular embodiment of a list report of an advertising campaign; and

FIG. 12 is a screenshot to illustrate a particular embodiment of an overlay interface.

### DETAILED DESCRIPTION

Digital brand lift may measure changes in audience awareness of a brand without subjecting audience members to surveys. For example, a set of traits may be established for users that visit an Internet property (e.g., a website) and users that use an application (e.g., an application executing on a computing device). In one embodiment, users “sign in” or otherwise identify their social networking profiles when visiting the property or using the application. An audience measurement system may retrieve data regarding the users from the social networks and from other data sources. Thus, the audience measurement system may determine a set of traits including geographic characteristics, demographic characteristics, psychographic characteristics, etc. of the audience. Digital brand lift may be considered an extension of this set of traits to collect and analyze behavioral information (e.g., how many users are interacting with advertising on the property/application, how long they interact, etc.). It should be noted that although systems and methods are described herein with reference to premium brand advertising, this is to be considered merely illustrative, and not limiting. In alternate embodiments, the described signal-based techniques may also be used to measure direct response advertising and other types of advertising (e.g., other types of advertising standardized by the Interactive Advertising Bureau (IAB) or another standardization organization). The described techniques may also be used to measure content. As used herein, “content” means non-advertising content. Examples of non-advertising content include text content (e.g., articles) and audio/video/graphics content that is not advertising-related.

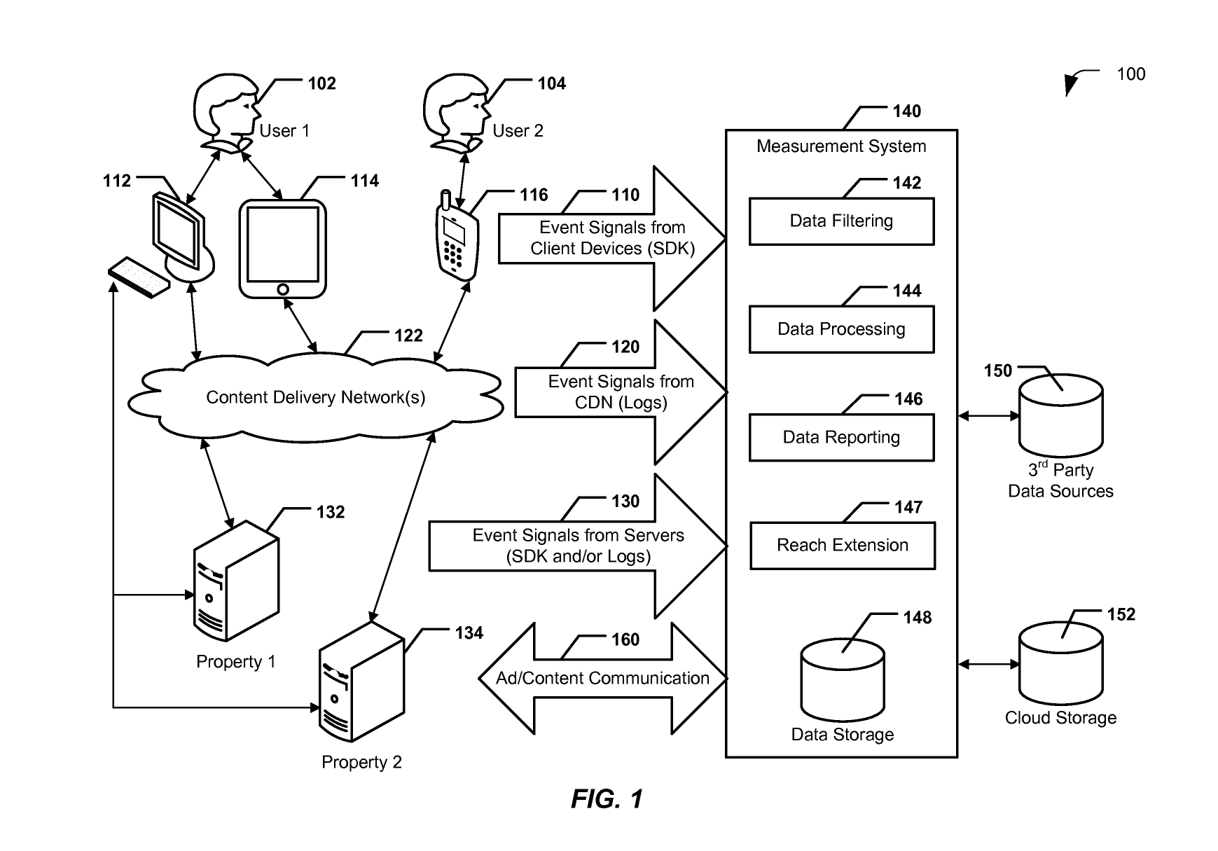

FIG. 1 illustrates an embodiment of a system that is operable to support measurement and modification of advertisements and content, and is generally designated 100. A measurement system 140 may be communicatively coupled to one or more user devices (e.g., illustrative user devices 112, 114, and 116), to one or more content delivery networks (CDNs) (e.g., illustrative CDN 122), and to media properties (e.g., websites) 132 and 134. In FIG. 1, the media properties 132 and 134 are illustrated by corresponding servers (e.g., web servers). The measurement system 140 may be implemented using one or more computing devices (e.g., servers). For example, such computing devices may include one or more processors or processing logic, memories, and network interfaces. The memories may include instructions executable by the processors to perform various functions described herein. The network interfaces may include wired and/or wireless interfaces operable to enable communication to local area networks and/or wide area networks (e.g., the Internet).

The user devices 112-116 may be associated with various users. For example, the desktop computing device 112 and the tablet computing device 114 may be associated with a first user 102, and the mobile telephone device (e.g., smartphone) 116 may be associated with a second user 104. It should be noted that the user devices 112-116 are shown for example only and are not to be considered limiting. In alternate embodiments, fewer, additional, and/or different types of user devices may be present in the system 100. For example, a radio-frequency identification (RFID)-enabled or Bluetooth® low energy (BLE)-enabled device may be carried by a user and may transmit a signal in response to detecting that the user is visiting a particular physical location (Bluetooth is a registered trademark of Bluetooth SIG, Inc. of Kirkland, Wash.). It should be noted that RFID and BLE are provided as examples and are not to be considered limiting. In alternative embodiments, different short-range network and/or personal area network (PAN) device technology may be used. In a particular embodiment, the user devices 112-116 may execute applications that are operable to access the media properties 132 and 134. For example, the user devices 112-116 may include applications developed using a mobile software development kit (SDK) that includes support for audience measurement functions. To illustrate, when the SDK-based applications interact with the media properties 132 and 134, the applications may generate first event signals 110 that are transmitted by the user devices 112-116 to the measurement system 140.

The first event signals 110 may include information identifying specific interactions by the users 102-104 via the user devices 112-116 (e.g., what action was taken at a media property, when the action was taken, for how long the action was taken, etc.). The user interactions may include interactions with advertisements presented by the media property and/or interactions with content presented by the media property. The event signals 110 may also include an identifier, such as a browser identifier (browser ID) generated by the SDK. In a particular embodiment, browser identifiers are unique across software installations and devices. For example, a first installation of a SDK-based application at the desktop computing device 112 and a second installation of the same SDK-based application at the tablet computing device 114 may use different browser IDs, even though both installations are associated with the same user 102.

In another particular embodiment, Browser IDs may remain consistent until applications or web browsers are “reset” (e.g., caches/cookies are cleared). In some embodiments, the user devices 112-116 may execute applications other than browser applications, such as downloadable mobile applications, that generate the event signals 110 based on user interactions with advertisements and/or content presented by the applications.

The user devices 112-116 may access content provided by the media properties 132 and 134 directly or via the CDN 122. The CDN 122 may provide distributed, load-balanced access to audio, video, graphics, and web pages associated with the media properties 132 and 134. For example, the CDN 122 may include geographically distributed web servers and media servers that serve Internet content in a load-balanced fashion. The CDN 122 may send second event signals 120 to the measurement system 140. The second event signals 120 may include information identifying interactions with media properties and browser IDs provided to the CDN 122 by the user devices 112-116 and/or the media properties 132 and 134. For example, the second event signals 120 may include CDN logs or data from CDN logs.

The media properties 132 and 134 may be controlled by the same entity (e.g., may be part of a federated property) or by different entities. The media properties 132 and 134 may send third event signals 130 to the measurement system 140. The third event signals 130 may include information identifying interactions with the media properties and browser IDs provided by the user devices 112-116 during communication with the media properties 132 and 134 (e.g., communication via hypertext transfer protocol (HTTP), transport control protocol/internet protocol (TCP/IP), or other network protocols).

In a particular embodiment, the third event signals 130 may include server logs or data from server logs. Alternately, or in addition, the third event signals 130 may be generated by SDK-based (e.g., web SDK-based) applications executing at the media properties 132 and 134, such as scripts embedded into web pages hosted by the media properties 132 and 134.

In a particular embodiment, the media properties 132 and 134 may send data to the measurement system 140 and receive data from the measurement system 140 regarding advertisements and/or content presented by the media properties 132 and 134. Such communication is illustrated in FIG. 1 as advertisement/content communication 160. For example, an advertisement (or software associated with the advertisement that is executing on a client device, such as web server, a computer, a mobile phone, a tablet device, etc.) may collect and transmit data on a per-advertisement, per-user basis. The data may include or identify a profile of a user, a duration that the user viewed the advertisement, action(s) performed by the user with respect to the advertisement, etc. As another example, a content item or software associated therewith may collect and transmit data regarding user interactions with the content item. Additional examples of data collected and transmitted regarding advertisements and content items are further described herein.

In a particular embodiment, the measurement system 140 includes a data filtering module 142, a data processing module 144, a data reporting module 146, and a reach extension module 147. In a particular embodiment, each of the modules 142-147 is implemented using instructions executable by one or more processors at the measurement system 140.

The data filtering module 142 may receive the event signals 110, 120, and 130. The data filtering module 142 may check the event signals 110, 120, and 130 for errors and may perform data cleanup operations when errors are found. The data filtering module 142 may also receive and perform cleanup operations on advertisement measurement data and content measurement data received from the media properties 132 and 134 and from applications executing on the user devices 112-116. In a particular embodiment, the data filtering module 142 may implement various application programming interfaces (APIs) for event signal collection and inspection.

The data filtering module 142 may store authenticated/verified event signals in a database, event cache, or archive, such as in data storage 148 and/or cloud storage 152. In a particular embodiment, the measurement system 140 includes or has access to a brand database that tracks brands. For example, “raw” data corresponding to the brand database and other collected data may be stored in the cloud storage 152. Signals received from the media properties 132 and 134 and from applications executing the user devices 112-116 may identify a brand that matches one of the brands in the brand database. The measurement system 140 may thus track advertisements/content for various brands across multiple media properties.

The data processing module 144 may process event signals stored in the database 148 or in an event cache or archive. In a particular embodiment, the data processing module 144 may process events based on rules and policies defined by an audience measurement entity (e.g., an owner/vendor of the measurement system 140).

The data processing module 144 may also associate received event signals (and interactions represented thereby) with user profiles of users. For example, when an event signal having a particular browser ID is a social networking registration event (e.g., when a user logs into a website using a Facebook® account, a Twitter® account, a LinkedIn® account, or some other social networking account), the data processing module 144 may retrieve a corresponding social networking profile or other user profile data from third party data sources 150. Facebook is a registered trademark of Facebook, Inc. of Menlo Park, Calif. Twitter is a registered trademark of Twitter, Inc. of San Francisco, Calif. LinkedIn is a registered trademark of Linkedln Corp. of Mountain View, Calif. In a particular embodiment, the social networking profile or other user profile data is received after an authentication process. For example, the measurement system 140 may receive a user token. The user token may enable the measurement system 140 to request a social network for information associated with a corresponding user.

It will be appreciated that interactions that were previously associated only with the particular browser ID (i.e., “impersonal” alphanumeric data) may be associated with an actual person (e.g., John Smith) after retrieval of the social networking profile or user profile. Associating interactions with individuals may enable qualitative analysis of the audiences of media properties. For example, if John Smith is a fan of a particular sports team, the measurement system 140 may indicate that at least one member of the audience of the first media property 132 or the second property 134 is a fan of the particular sports team. When a large percentage of a media property's audience shares a particular characteristic or interest, the media property may use such information in selecting and/or generating advertising or content. User profiles (e.g., a profile of the user John Smith) and audience profiles (e.g., profiles for the media properties associated with the media properties 132 and 134) may be stored in the data storage 148, the cloud storage 152, and/or in another database. An audience profile for a particular media property may be generated by aggregating the user profiles of the individual users (e.g., including John Smith) that interacted with the particular media property.

Audience profiles may be generated using as few as one or two user profiles, although any number of user profiles may be aggregated. In a particular embodiment, audience profiles may be updated periodically (e.g., nightly, weekly, monthly, etc.), in response to receiving updated data for one or more users in the audience, in response to receiving a request for audience profile data, or any combination thereof. Audience profiles may similarly be generated for audiences of a particular mobile application based on signals generated by installations of the mobile application on various user devices.

The data processing module 144 may also be configured to, upon receiving an event signal, parse the event signal to identify what user and media property the event signal corresponds to. The data processing module 144 may store data corresponding to the event signal in one or more databases (e.g., the cloud storage 152, the data storage 148, a user profile database, etc.). If the user is a new audience member for the media property, the data processing module 144 may assign a new ID to the user.

In a particular embodiment, the data processing module 144 may also process advertisement/content data received from the properties 132 and 134 and from applications executing on the user devices 112-116. For example, the data processing module 144 may calculate advertisement performance metrics on a per-advertisement basis, per-advertising campaign basis, per-brand basis, per-advertisement placement basis, per-advertisement context basis, etc. As another example, the data processing module 144 may calculate content performance metrics on a per-content item basis, per-brand basis (e.g., in the case of content that is associated with or sponsored by a particular brand), per-content placement basis, per-content context basis, etc. Examples of advertisement performance metrics and content performance metrics are further described herein.

The data reporting module 146 may generate various interfaces based on the data stored in the data storage 148 and/or the cloud storage 152. The data reporting module 146 may also support an application programming interface (API) that enables external devices to view and analyze data collected and stored by the measurement system 140. In a particular embodiment, the data reporting module 146 is configured to segment the data. In a particular embodiment, the measurement system 140 may be operable to define “new” segments based on performing logical operations (e.g., logical OR operations and logical AND operations).

As used herein, a “segment” is based on (or corresponds to) a group of people (e.g., an audience or a subset thereof). As further described herein, a set of traits may be determined for each segment. In an illustrative embodiment, the set of traits for a segment corresponds to a Digital Genome® set of traits of the segment (Digital Genome is a registered trademark of Umbel Corporation of Austin, Tex.). Examples of segments include, but are not limited to, brand affinity segments (also called brand segments), demographic segments, geographic segments, social activity segments, employer segments, educational institution segments, professional group segments, industry category of employer segments, brand affinity category segments, professional skills segments, job title segments, and behavioral segments. In a particular embodiment, behavioral segments are defined by a client (e.g., property owner or publisher) or by the measurement system 140, and represent actions taken on a client's property, such as “watched a video,” “read an article,” “made a purchase,” etc. In this context, “property” refers to a media property, such as media content, a website, etc. Additional examples of segments include segments based on an advertisement, an advertisement campaign, an advertisement placement, an advertisement context, a content item, a content context, content placement, etc. As another example, a segment may be generated based on a platform (e.g., desktop/laptop computer vs. mobile phone vs. tablet computer). For example, a “tablet segment” may include users that viewed a media property using a tablet computing device. Segments may be used to evaluate characteristics of an audience, craft a content strategy, generate advertising leads, create advertising pitches, and respond to inbound advertising requests.

In a particular embodiment, the data reporting module 146 sends the properties 132 and 134 data regarding digital brand lift, a set of traits of an audience or segment, individual advertisements, advertisement campaigns, individual content items, etc. Based on the received data, advertisements (or content items) on the properties 132 and 134 may self-modify. As used herein, “self-modification” by an advertisement (or content item) refers to implementing a change in at least one characteristic of the advertisement (or content item) without receiving an instruction to implement such a change. For example, if the data indicates that an advertisement (or content item) is underperforming in terms of views, the advertisement (or content item) may self-modify to increase its viewability (e.g., number of unique views). Additional advertisements (or content items) may also be deployed. Examples of such advertisement (or content) modification are further described herein.

During operation, the users 102-104 may interact with the media properties 132 and 134 and with applications executing on the user devices 112-116. In response to the interactions, the measurement system 140 may receive the event signals 110, 120, 130, and/or 160. Each event signal may include a unique identifier, such as a browser ID and/or an audience member ID. If the user is a “new” audience member, the data processing module 144 may create a user profile. Data for the user profile may be stored in the cloud storage 152 and/or the data storage 148. In a particular embodiment, data for the user profile may be retrieved from the third party data sources 150.

For example, the data processing module 144 may retrieve and store data from one or more social network profiles of the user. The data may include demographic information associated with the user (e.g., a name, an age, a geographic location, a marital/family status, a homeowner status, etc.), social information associated with the user (e.g., social networking activity of the user, social networking friends/likes/interests of the user, etc.), and other types of data. The data processing module 144 may also collect and store data associated with advertisements and content served by the media properties 132 and 134 and by applications executing on the user devices 112-116. In a particular embodiment, the measurement system 140 is further configured to receive offline data from external data sources. For example, the measurement system 140 may receive data regarding transactions (e.g., purchases) made by an audience and may use the transaction data to generate additional signals that contribute to a set of traits of an audience, brand, property, etc. Another example of offline data may be a “data dump” of data collected by an RFID-enabled or BLE-enabled device or an RFID/BLE detector. Offline data may be stored in one or more computer-readable files that are provided to the measurement system 140. In a particular embodiment, offline data can include previously collected data regarding users or audience members (e.g., names, addresses, etc.).

The data reporting module 146 may report data collected by the measurement system 140. For example, the data reporting module 146 may generate reports based on an audience profile of a media property (or application), where the audience profile is based on aggregating user profiles of users that interacted with the media property (or application). To illustrate, the data reporting module 146 may generate an interface indicating demographic attributes of the audience as a whole (e.g., a percentage of audience members that are male or female, percentages of audience members in various age brackets, percentages of audience members in various income bracket, most common audience member cities/states of residence, etc.). The interface may also indicate social attributes of the audience as a whole (e.g., the most popular movies, sports teams, etc. amongst members of the audience). Audience profiles may also be segmented and/or aggregated with other audience profiles, as further described herein. Audience profiles may further be segmented based on advertisement, advertisement campaign, brand, content item, etc. as further described herein. Audience profiles may also be constructed by combining segments. In an example, the data reporting module 146 may generate interfaces describing the audience for a particular advertisement or advertising campaign. In a particular embodiment, the data reporting module 146 outputs data to the properties 132 and 134 (or to mobile applications), which may enable advertisements (or content) at the properties (or mobile applications) to self-modify to better achieve advertising campaign goals (or other content-related goals).

In a particular embodiment, the reach extension module 147 initiate messaging actions based on audience attributes, as further described herein. For example, a media producer may initiate a messaging action in an attempt to cause an individual to perform a desired action (e.g., buy a product, form a particular opinion, join a cause, enroll in a program, watch a video, read an article, etc.) The reach extension module 147 may initiate messaging actions based on attributes of an audience made of people who have performed the desired action. In a particular non-limiting example, initiating a messaging action corresponds to purchasing targeted advertising. In other non-limiting examples, initiating a messaging action corresponds to a different type of communication. In the context of targeted internet advertising, “purchasing” targeted advertising directed to a particular attribute refers to placing a bid with an advertising network (e.g., a social network that advertises to users, a search engine that inserts advertisements in search results web pages, etc.) for the opportunity to advertise to members/users of the advertising network that exhibit the particular attribute. Bids may be placed in terms of cost per mille (thousand impressions) (CPM), cost per click (CPC), or cost per action (CPA), as illustrative non-limiting examples. For example, an advertiser may place a CPC bid of $1.25 targeting unmarried users of a social network. If the advertiser's bid is accepted, the advertiser's advertisement(s) are presented to unmarried users of the social network and the advertiser is charged $1.25 each time a user of the social network clicks on the advertisement(s).

The system of FIG. 1 may thus enable audience measurement and analysis based on data (e.g., event signals) received from various sources, where the data is generated in response to user interactions with websites, web pages, audio items, video items, games, and/or text associated with various media properties, as illustrative non-limiting examples. In a particular embodiment, the system 100 may also receive event signals based on measurements (e.g., hardware measurements) made at a device. For example, an event signal from the tablet computing device 114 or the mobile telephone device 116 may include data associated with a hardware measurement at the tablet computing device 114 or the mobile telephone device 116, such as an accelerometer or gyroscope measurement indicating an orientation, a tilt, a movement direction, and/or a movement velocity of the tablet computing device 114 or the mobile telephone device 116. As another example, the system 100 may receive a signal in response to an RFID and/or BLE device detecting that a user is visiting a particular physical location. The system 100 of FIG. 1 may also link interactions with user profiles of users. This may provide information of “how many” viewers and “how long” the viewers watched a particular video (e.g., as in direct response measurement systems), and also “who” watched the particular video (e.g., demographic, social, and behavioral attributes of the viewers).

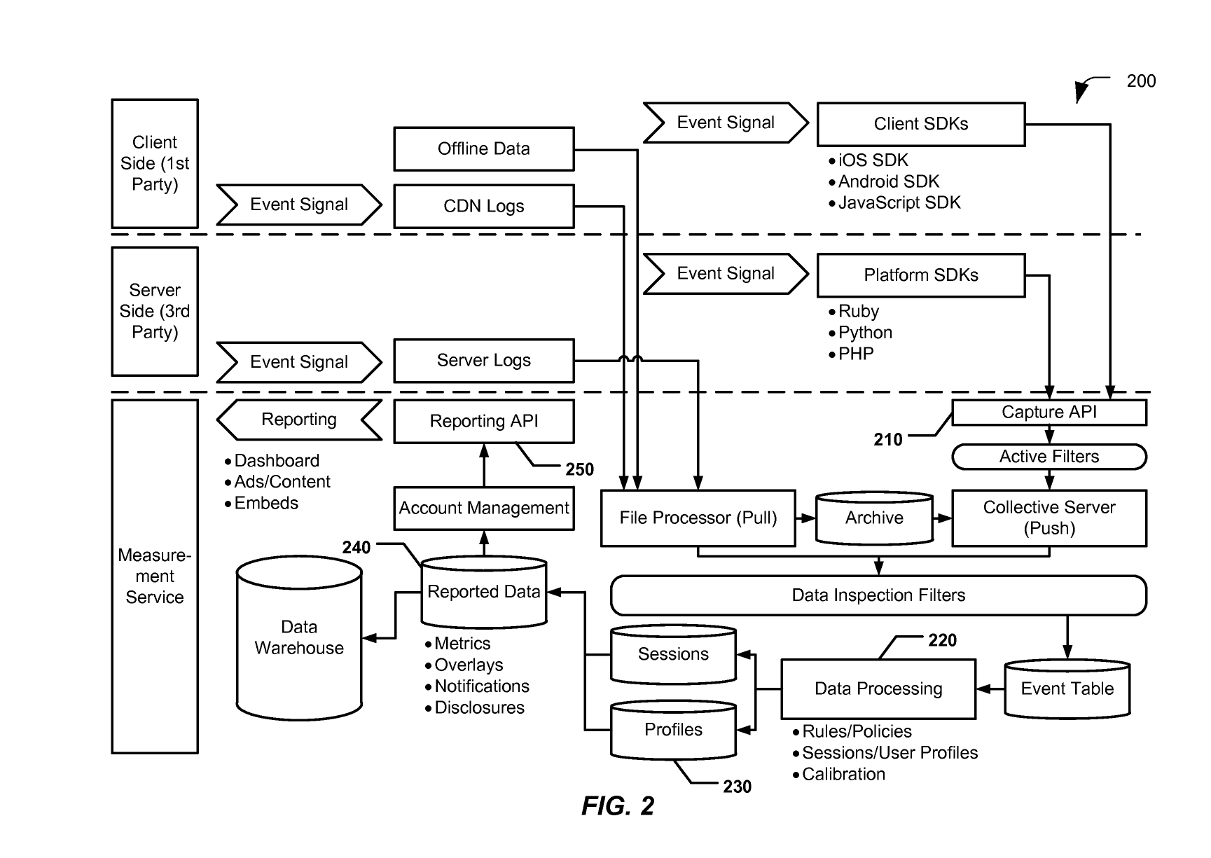

Further, the system of FIG. 1 may enable implementation of premium brand advertising. For example, the measurement system 140 may determine brand lift based on signals received from the properties 132 and 134 and/or mobile applications regarding user interactions with particular advertisements and/or content items. To illustrate, before an advertising campaign for a particular brand commences, the measurement system 140 may determine characteristics of the users that visit the properties 132 and 134. One such audience characteristic may be a brand affinity for the particular brand, which may be determined at least in part on how many audience members have “liked” the brand on a social network, mentioned the brand in a social networking communication, etc. During the advertising campaign, the measurement system 140 may receive data indicating how audience members viewed and interacted with the various advertisements involved in the campaign. Comparing in-campaign audience characteristics to pre-campaign audience characteristics may provide a measure of brand lift (e.g., awareness change) for the particular brand. In a particular embodiment, awareness may include or correspond to perception change (e.g., positive perception change and/or negative perception change). If advertising goals are not being met, the advertisements in the campaign may self-modify based on data provided by the measurement system 140. The measurement system 140 may also continue to track brand lift after the campaign is completed based on received signals. Further information regarding determining digital brand lift and advertisement/content measurement is provided with reference to FIGS. 2-12.

FIG. 2 is a diagram to illustrate another particular embodiment of a system 200 that is operable to support measurement and modification of advertisements and content. As shown in FIG. 2, a measurement service (e.g., running at the measurement system 140 of FIG. 1) may receive first party (e.g., client side) event signals from CDN logs and from applications developed via client SDKs (e.g., iOS®, Android®, and/or JavaScript SDKs). iOS® is a registered trademark of Apple Inc. of Cupertino, Calif. Android® is a registered trademark of Google Inc. of Mountain View, Calif. The measurement service may also receive third party (e.g., server side) event signals from server logs and from applications developed via platform SDKs (e.g., Ruby, Python, and/or PHP: Hypertext Preprocessor (PHP) SDKs).

Event signals received via SDKs may be provided to one or more active filters (e.g., the data filtering module 142 of FIG. 1) via a capture API 210, as shown in FIG. 2. The capture API 210 may also receive advertisement/content data (e.g., signals) from servers (e.g., servers associated with the properties 132 and 134 of FIG. 1) and/or from applications executing on user devices. In a particular embodiment, the advertisement/content data includes push event notifications that are generated in response to certain events occurring at the properties 132 and 134 and/or the applications. For example, the properties 132 and 134 and/or the applications may provide data using the capture API 210 in response to advertisement/content impressions, views, goals, and/or engagements (e.g., likes, mentions, sharing, following, check-ins, etc. on a social network, etc.). In a particular embodiment, users carry RFID and/or BLE tags and the engagements include signals indicating that a user has visited a particular physical location (e.g., an advertising booth). An advertisement/content signal may also include profile information (e.g., a profile ID, a browser ID, etc.) regarding a user whose action(s) caused the generation of the advertisement/content signal. Advertisement signals may be received before, during, and after advertising campaigns.

The active filters may provide the event signals to a push-based collection server, which stores the event signals in an archive. Event signals received via CDN logs, server logs, and offline data (e.g., files that include RFID/BLE data, transaction data, etc.) may be provided to a pull-based file processor, which stores the received event signals in the archive. One or more data inspection filters (e.g., the data filtering module 142 of FIG. 1) may inspect the archived event signals and create/modify event tables that represent the event signals. A data processing module 220 (e.g., the data processing module 144 of FIG. 1) may process the event table(s) and associate the various events to sessions and profiles 230 (e.g., user profiles). The data processing module 220 may use defined rules and policies and may perform data calibration operations. The data processing module 220 may also compute advertisement/content metrics. For example, based on advertisement/content signals being received via the capture API 210, the data processing module 220 may compute digital brand lift, how individual advertisements/content items are performing, how an advertising campaign is performing, etc.

The sessions and profiles 230 may be used to generate reported data 240 that is stored in a data warehouse. The reported data 240 may include an aggregate of all data for a media property (e.g., event data and information related to all users that have interacted with the media property), for a particular advertisement, a particular advertising campaign, a particular brand, a particular advertisement placement, a particular advertisement context, a particular content item, a particular application, a particular platform, etc. The reported data 240 may include or be used to generate one or more metrics, one or more overlays, one or more notifications, and/or one or more disclosures that are computed based on the output of the data processing module. In a particular embodiment, the reported data 240 may also include external data that is received from one or more external data sources (e.g., the third party data sources 150). To illustrate, external data from a market research company may indicate that 8% of adults in the Boston, Massachusetts area are likely to own a particular type of automobile. An overlay may apply this external data to an individual user profile to determine the likelihood that a user owns the particular type of automobile. An overlay may also apply the external data to an audience profile to determine a likelihood and number of audience members owning the particular type of automobile. Information from such overlays may be used by the media property to select and price advertising and/or drive new content generation (e.g., to add advertisements and/or articles regarding the particular type of automobile or automobiles in general).

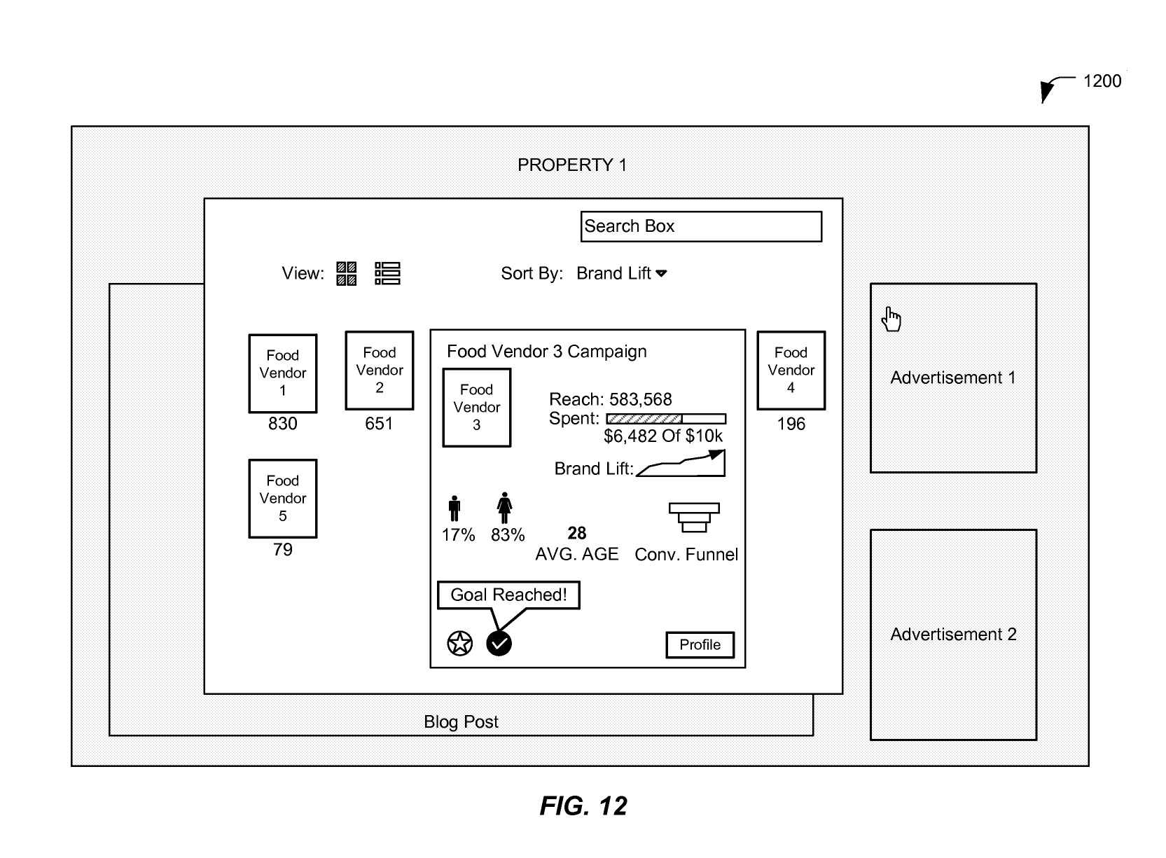

An account management module may provide the reported data to a reporting API 250 (e.g., the data reporting module 146 of FIG. 1) that generates various reporting interfaces, such as an audience measurement dashboard, advertisements/content items, and items that maybe embedded into existing documents, reports, and communications. An audience measurement dashboard may be a website that a client can log in to, a control panel, an on-site overlay (e.g., as described with reference to FIG. 12), or some other type of dashboard that presents reporting data.

In a particular embodiment, the reporting API 250 generates reports that present segmented data on a per-advertisement basis, per-advertisement campaign basis, per-brand basis, per-context basis, per-content item basis, per-platform basis, per-user basis, etc. The reporting API 250 may also provide (e.g., push) data to the advertisements/content items running on properties (e.g., the properties 132 and 134 of FIG. 1) or on mobile applications. For example, the data provided by the reporting API 250 to a particular advertisement/content item may include profile data regarding users that have viewed/interacted with the particular advertisement/content item, brand lift, aggregate data for an advertising campaign that a particular advertisement is a part of, etc. Based on the data, the advertisements/content item may self-modify (e.g., self-optimize) in real-time or near-real-time to better achieve campaign goals. For example, the particular advertisement/content item may relocate within a web page or application, may be presented on more/fewer/different web pages or properties, etc. In a particular embodiment, an advertisement/content item may also change images/sounds presented in association with the advertisement/content item. For example, the advertisement/content item may present different images/sounds depending on whether the data indicates that a particular user (or a majority of viewing/engaging users) has a particular demographic characteristic (e.g., is male or female). As another example, if the data indicates that the advertisement/content item is not being viewed by the right group of people (e.g., the data indicates that a high percentage of males are viewing the advertisement although the advertisement campaign is targeted towards females), the advertisement/content item (or the property) may initiate actions to acquire a more desirable audience (e.g., more females). Actions to acquire more users that are “similar” to an audience or a subset of audience members may also be generated. It should be noted that the above examples regarding male/female users are for example only. Various geographic, demographic, psychographic characteristics, and/or social characteristics of an audience may be tracked and reported by the system 200 of FIG. 2.

The system 200 of FIG. 2 may thus, in real-time or near-real-time, capture demographic and behavioral data about users of websites and applications, transform the captured data into metrics, enable segmenting of audience information based on the data and metrics, and report aggregate information about such segments, including reporting of digital brand lift and segmentation by advertisement, advertising campaign, content item, etc. The system 200 may also submit a reach extension campaign request in response to determining that an advertiser guarantee is unlikely to be fulfilled, or may launch a reach extension campaign to change audience member composition to be more desirable to an advertiser. Advantageously, the system 200 of FIG. 2 may provide information about a particular segment as a whole and may suggest other subsets or segments of the audience that may be similar to the particular segment.

To support the various event capturing and reporting functions described with reference to FIGS. 1-2, client side software and capture software may be provided to media properties. For example, client side software may be provided to an owner of a web page or application (e.g., property) so that the software can be embedded into the web page or application (e.g., an application that is executable on a mobile computing device). The software may include software associated with collection and processing of advertisement data associated with advertisements presented by the web page or application. Once embedded, the software may generate and send event signals to a measurement system (e.g., the measurement system 140 of FIG. 1 or the system 200 of FIG. 2). The event signals may be used in various ways, including gathering information about individual users from third party sources, aggregating information about advertisement campaigns, measuring digital brand lift, etc. Client side software may include scripts on web pages and an SDK for application development. As described above, social registration may also be used by the measurement system. For example, when a social registration occurs, the measurement system may query, on the media property's behalf, the corresponding social registration provider to collect data about the user. This data collection may be performed in a timely manner and at scale (e.g., because the social registration may have an associated validity/expiration time).

Capture software may receive, parse, and store data in the form of a log file or a data object. The data may be used to calculate metrics and generate reporting interfaces, as described herein. For example, the metrics may include industry standard metrics regarding audio, video, application, and game consumption. Social media metrics that are not standardized by industry may also be created. Advantageously, a cross-media metric may be calculated to unify media consumption across multiple types of media (e.g., audio, video, game, text, and online social behavior). The described techniques may create reports that include side-by-side presentations of both existing industry metrics as well as cross-media and social behavior metrics.

A particular metric enabled by the described techniques is a consumability metric that defines whether the electronic delivery of media (e.g., content or advertising) was actually consumed. An example of media not being consumed includes, but is not limited to, a video that is playing off-screen and therefore not actually being seen. The present disclosure may thus provide the ability to build segments around media being seen and other segments around media that was recently loaded onto a web page. An advertiser may perform different actions based on the different types of media.

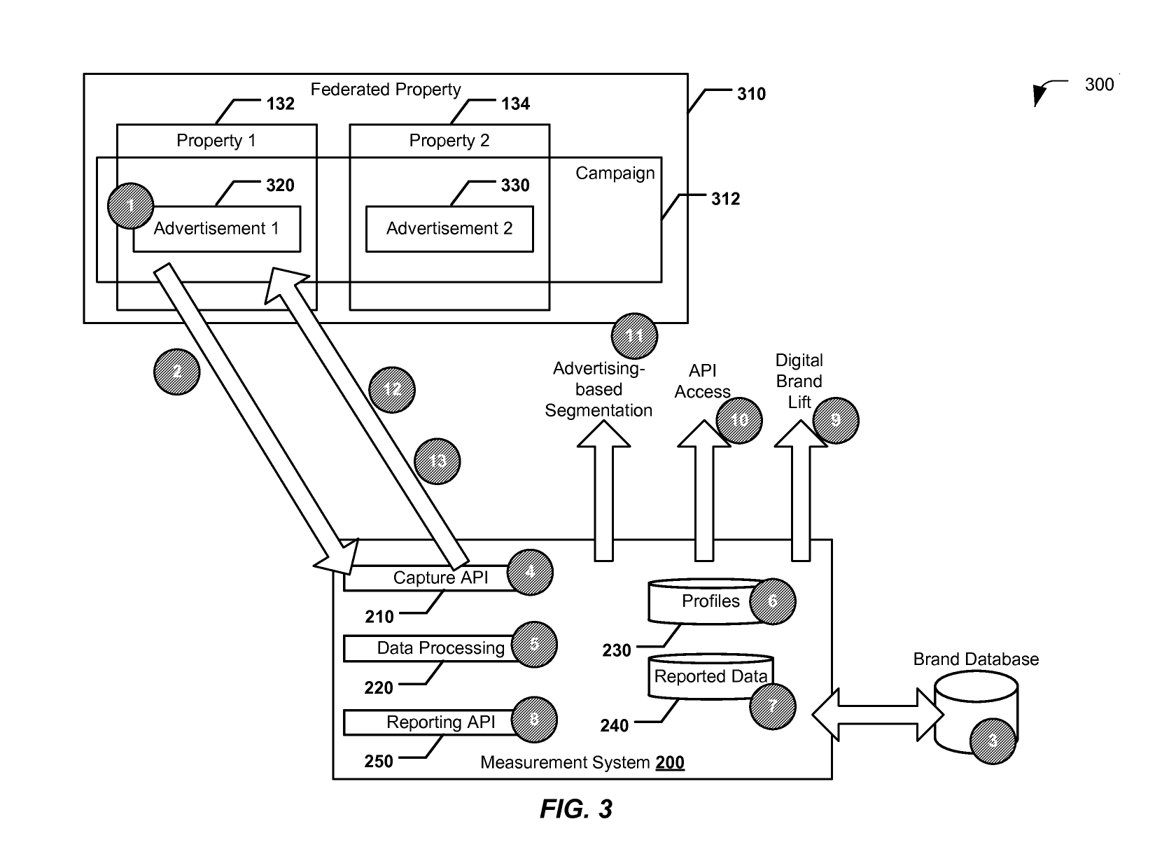

FIG. 3 is a diagram to illustrate data flow in the measurement system 200 of FIG. 2 and is generally designated 300. For ease of illustration, only selected components of the measurement system 200 of FIG. 2 are shown in FIG. 3.

As shown in FIG. 3, the properties 132 and 134 may be part of a federated property 310. For example, the properties 132 and 134 may be two different web sites (e.g., blogs) that are owned by or affiliated with a common publisher. In FIG. 3, the first property 132 includes a first advertisement 320 and the second property 134 includes a second advertisement 330. In a particular embodiment, the advertisements 320 and 330 are part of the same campaign 312. The first advertisement 320 may collect data regarding users viewing or engaging with the first advertisement 320, as well as data regarding the specific actions performed by such users, as indicated at 1. The first advertisement 320 may transmit advertisement signals to the capture API 210, as shown at 2.

The advertisement signals may include data that can be used to correlate users, advertisements, and advertising campaigns. For example, the advertisement signals may include profile information or a profile identifier (ID) or browser ID of the user. As another example, the advertisement signals may include a brand ID that corresponds to a brand in a brand database, as described with reference to FIG. 1. The advertisement signals may also include a campaign ID used to track a particular advertising campaign and an advertisement ID used to track the first advertisement 320. The advertisement signals may include a platform indicating whether the first advertisement 320 appeared on a desktop/laptop computing device, a mobile computing device (e.g. mobile phone), or a tablet computing device. The advertisement signals may also include data identifying a context (e.g., scope) of the first advertisement 320. For example, the context of the first advertisement 320 may include where on the first property 132 the first advertisement 320 appeared (e.g., what specific web page, what hierarchical location on the property 132, etc.). The advertisement signals may further include a placement of the advertisement 320 on a web page and an advertisement type. In a particular embodiment, the advertisement signals include tracking codes (e.g., Urchin Traffic Monitor (UTM) codes) and identify a referring web page that led to the first advertisement 320 being viewed.

An example of a push event (e.g., advertisement signal) generated by an advertisement of a July 2013 campaign for the brand Cola is provided below:

_adMeasurement.push({

“type”: “send”,
“name”: “campaign.tag”,
“value”:{

“brand”: “Cola”
“campaign”: “Cola_2013_07”
“ad”: “Cola_01045”
“platform”: “desktop”
“context”: [“sports articles”, “TV”]
“placement”: “right rail”

}

});

As shown in the above example, certain advertisement signals may include a “campaign.tag” event type. Event types may be used to define segments of an audience engaging with an advertisement. Various types of events may be supported by the measurement system 200. For example, the “campaign.tag” event may correspond to an advertisement impression and may be triggered when the web page containing an advertisement is loaded. A “campaign.view” tag may be triggered when the advertisement is on-screen and fully rendered:
_adMeasurement.push({“type”: “send”, “name”: “campaign.view”, “value”:<adID>});

A “campaign. engagement” tag may be triggered when particular actions are performed with respect to the advertisement. “Engagements” may be actions taken by a user, including but not limited to clicking on a link, watching a video, commenting, liking, sharing, mentioning, following, checking-in, and purchasing. In a particular embodiment, advertisers and property owners can define engagements for which data collection is desired. Advertisers and property owners may also be able to define what constitutes a “view” vs. an “impression.” Engagements may occur with respect to advertisements and advertising campaigns. Engagements can also occur with respect to content and can be segmented by metadata associated with the content (e.g., an author of the content). Engagements may occur offsite with respect to a brand (e.g., a brand included in the brand database described with reference to FIG. 1). An example of a “campaign.engagement” signal for a user click is:

_adMeasurement.push({“type”: “send”, “name”: “campaign.engagement”,

“value”: [<adID>, “click”] });

A “campaign.goal” event may represent a conversion event or activity. Advertisements tracked by the measurement system 200 may be tracked and measured against advertising campaign goals. If the campaign is not reaching these goals, the measurement system 200 (or the individual advertisements) may trigger alerts to an advertiser or property owner. Methods to reach the goals may also be suggested. Examples of campaign goals include, but are not limited to, advertisement reach (e.g., unique impressions of the advertisement), impressions (e.g., total impressions), reach and impressions per-hour and per-day, frequency of impressions or unique impressions, clickthrough rate (e.g., conversion), etc. Goals may further be refined based on profile data (e.g., instead of merely being five thousand impressions, the goal may be five thousand impressions by females aged 25-35 having an income of $50,000 or above). An example of a “campaign.goal” event is:
_adMeasurement.push({“type”: “send”, “name”: “campaign. goal”, “value”:<adID>});

In a particular embodiment, the measurement system 200 uses a common key to track a particular user's actions throughout a site (e.g., property). The common key may be a cookie that is tied to a particular domain. If a client has multiple domains and shares user sessions across the domains, a “profile.unique” key may be used. For example, the “profile.unique” key may be a universally unique identifier (UUID) that is set at least once in each domain:

_adMeasurement.push({“type”: “set”, “name”: “profile.unique_id”,

“value”: “fffe8239-e32e-7f8b-9c8d-0b22a” });

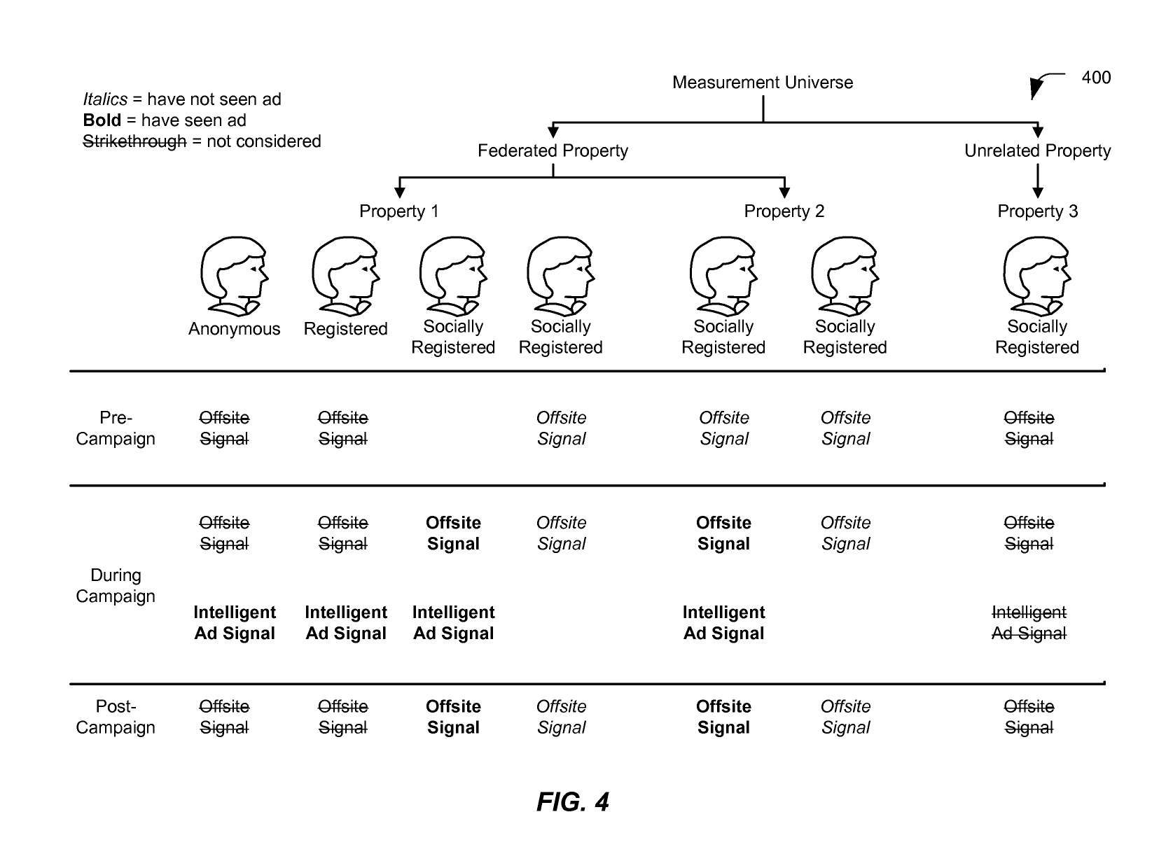

The measurement system 200 may identify what brand the first advertisement 320 is associated with (e.g., based on the brand ID included in received advertisement signals), as indicated at 3. At 4, the capture API 210 may collect and provide advertisement signals to the data processing module 220. At 5, the data processing module 220 may identify demographic, geographic, social, professional, and/or conversational characteristics of the audience of the first advertisement 320 (e.g., based on the profiles 230, as shown at 6). The data processing module 220 may also compute digital brand lift for the brand, as further described with reference to FIGS. 4-9. At 7 and 8, the reported data 240 may be made available by the reporting API 250. For example, digital brand lift for the brand may be reported, at 9. As another example, API-based access to advertisement performance metrics may be supported, at 10. As yet another example, interfaces that segment the advertising data on a per-advertisement and/or per-campaign basis may be generated and reported, at 11. Examples, of such interfaces are further described herein.

Advertisement information may be reported back to the first advertisement 320, as shown at 12. Based on the information, the first advertisement 320 may self-modify to better achieve campaign goals. Advertisement information may also be reported to the property 132 for use in generating a reporting overlay, as shown at 13 and further described with reference to FIG. 12. The overlay may enable an owner of the property 132 (e.g., a publisher) to see advertisement tracking data alongside or overlaid on top of the advertisements that contributed to the advertisement tracking data.

It should be noted that although FIG. 3 is described with reference to the measurement and modification of advertisements on media properties, this is for example only. The described techniques may also support measurement and modification of (non-advertising) content. For example, content measurement signals similar to the advertisement measurement signals described above may be sent in response to views, impressions, goal-related events, and/or engagements with content. Further, the described techniques may operate with respect to applications (e.g., applications executing on a mobile computing device), and not just with respect to media properties.

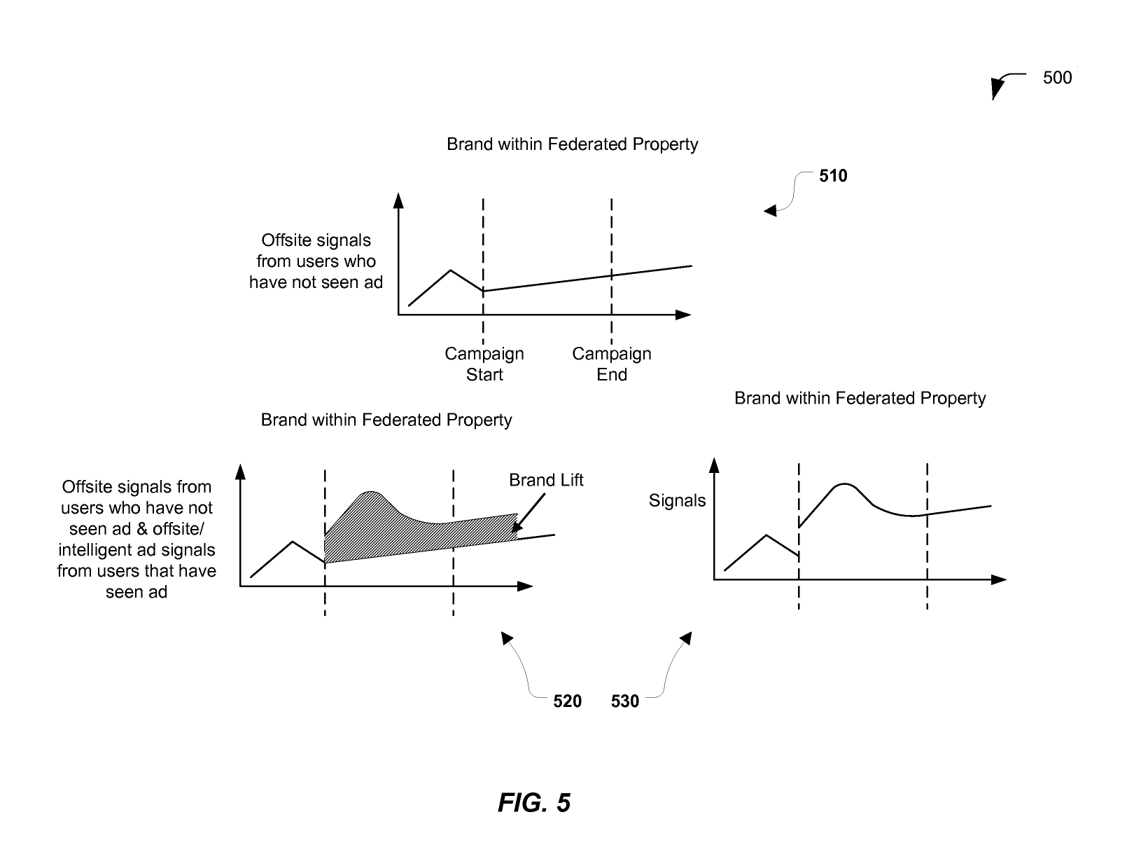

FIG. 4 is a diagram to illustrate an example of using received signals to compute metric(s) within a federated property, as is generally designated 400. FIG. 5 depicts graphs to illustrate computed brand lift based on the signals of FIG. 4, and is designated 500.

In the example of FIG. 4, the measurement universe includes a federated property including property 1 and property 2, and an unrelated property including property 3. Property 1 is associated with four users, including one anonymous user, one registered user (e.g., registered using a user name and password), and two socially registered users (e.g., registered using a social networking account). Property 2 is associated with two socially registered users and property 3 is associated with one socially registered user.

Prior to the advertising campaign (“Pre-Campaign”), the measurement system receives offsite signals from various users, as shown. The signals are considered “offsite” signals because the signals are not generated on property 1, property 2, or property 3. Examples of such offsite signals include signals received from social networking profiles of the users and signals generated based on other actions taken by the users. In FIG. 4, font-styles are used to distinguish different signals. Signals that are shown in italics or bold are signals that the measurement system can use to compute brand lift. In particular, signals in italics correspond to signals received from users that have not seen a particular advertisement and signals in bold correspond to signals received from users that have seen the particular advertisement. Signals in strikethrough are not considered during computation of brand lift.

During the advertising campaign (“During Campaign”), the measurement system may receive offsite signals as well as advertisement signals from the particular advertisement. Notably, the in-campaign signals include offsite signals from socially registered users that view the particular advertisement as well as advertisement signals from anonymous and non-socially registered users that view the particular advertisement, and such signals are taken into account when determining brand lift. In FIG. 4, the advertisement signals are designated “Intelligent Ad Signal.” After the campaign (“Post-Campaign), the measurement system may continue to receive offsite signals, as shown. Thus, the system may continue to distinguish between people that saw the particular advertisement and people that did not see the particular advertisement, even once the advertising campaign has concluded.

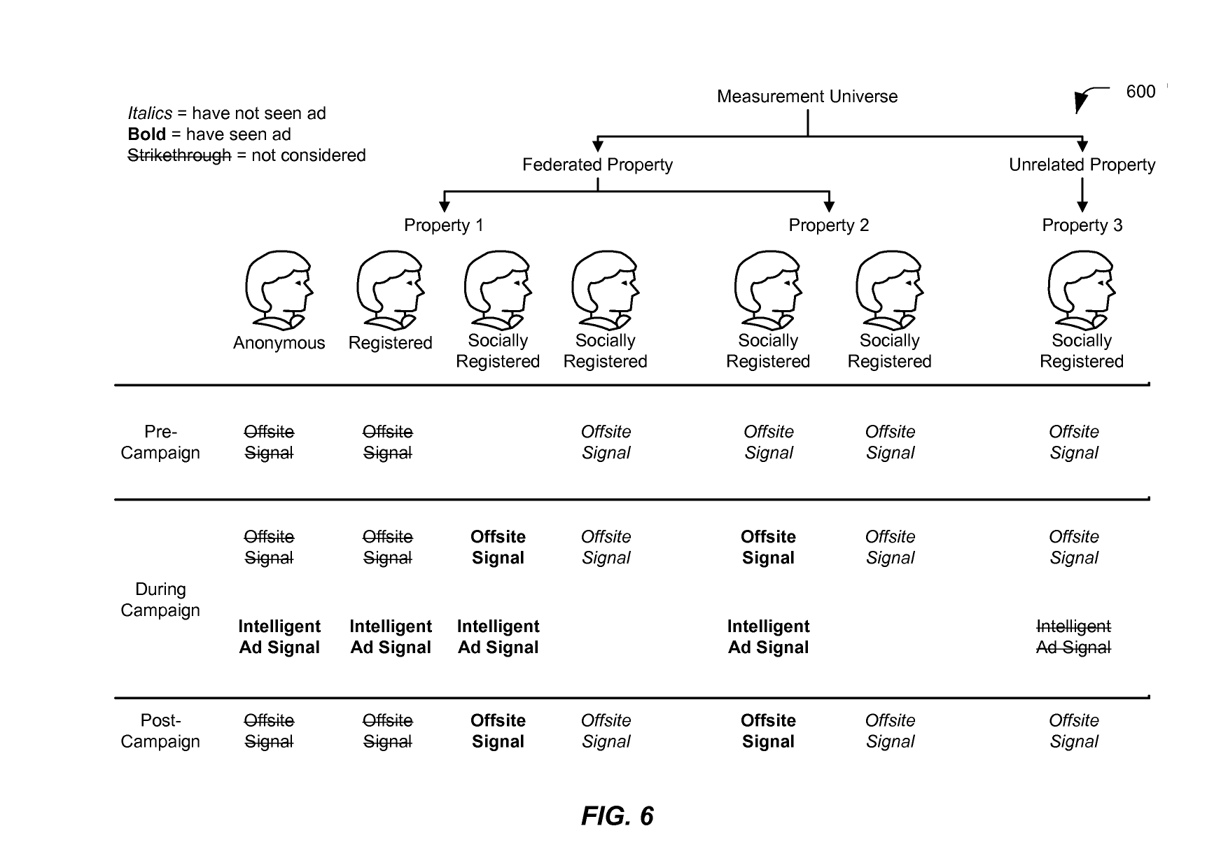

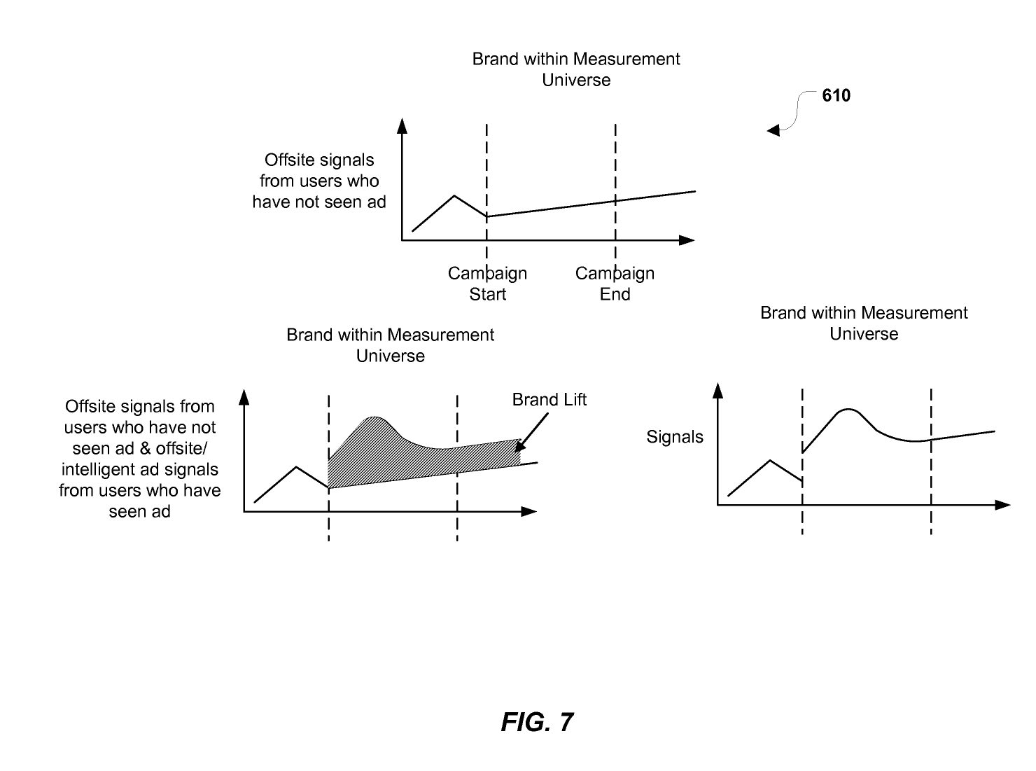

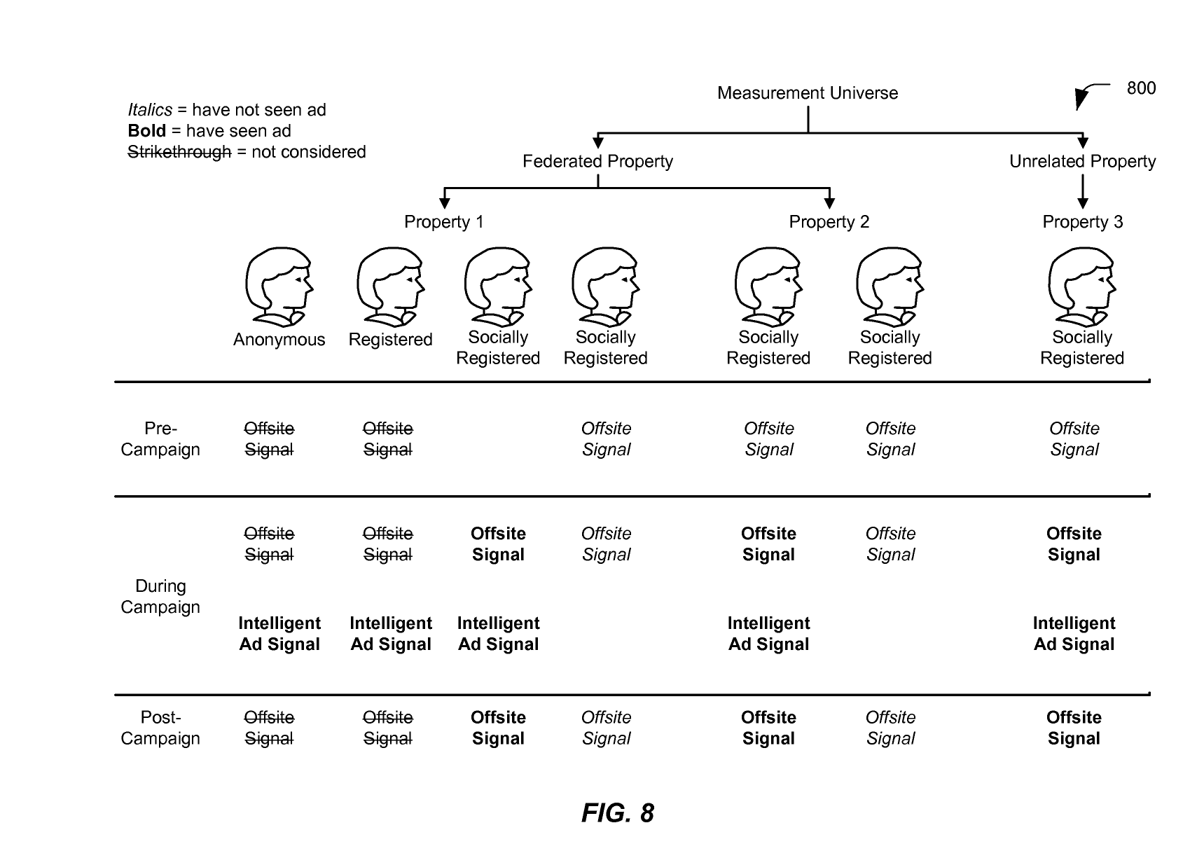

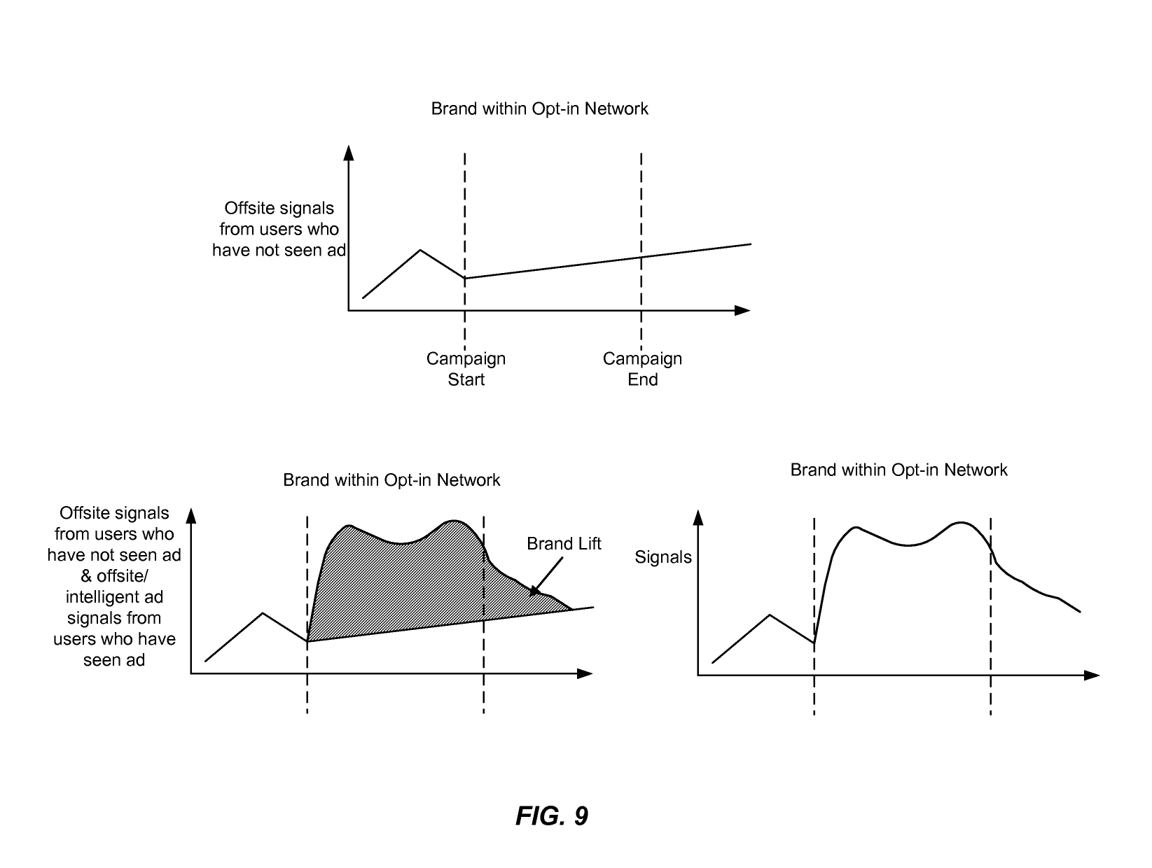

Based on the offsite signals and advertisement signals, the measurement system may compute digital brand lift (DBL). For example, DBL may be calculated for an advertisement or an advertisement campaign based on the difference between: 1) a number of onsite and/or offsite pre-campaign, in-campaign, and/or post-campaign signals, associated with the brand, from users who have been presented an advertisement/campaign, and 2) a number of onsite and/or offsite pre-campaign, in-campaign and/or post-campaign signals, associated with the brand, from users who have not been presented the advertisement/campaign. The difference may be computed within a property (e.g., as shown in FIGS. 4-5), within a federated property (e.g., as shown in FIGS. 6-7), or within an opt-in network (e.g., as shown in FIGS. 8-9). In a particular embodiment, the signals used to compute DBL are multiplied by a weighted decaying factor that varies based on the age and type of the signal. For example, an impression signal may have a particular weight (e.g., 0.5) that decays linearly or non-linearly over a particular time period (e.g., 5 days). Some types of engagements may not decay to zero, because the engagements may be ongoing. For example, when a user “likes” a brand on a social network, the “like” engagement signal may not decay to zero while the user continues to “like” the brand. In a particular embodiment, advertisement signals are unique signals on a per-user basis. For example, an impression may be recorded once for each viewer of the advertisement. If the impression signal occurs again (e.g., the viewer sees the advertisement again), the clock on the weighted decay for the impression signal may be reset. Examples of weights for selected signals are shown in Table 1 below. In alternate embodiments, other weighting methods, weights, and/or events may be used.

TABLE 1

| | Impression | Views | Goals | Click | Like | Mention | Share | Follow | Purchase |
|---|---|---|---|---|---|---|---|---|---|
| Max | 0.05 | 0.5 | 1 | 1.15 | 1.25 | 1.25 | 1.5 | 1.75 | 2 |
| Weight | | | | | | | | | |
| Min | 0 | 0 | 0 | 0 | 0.5 | 0 | 0 | 0.5 | 0 |
| Weight | | | | | | | | | |
| Decay | 5 | 10 | vary | 14 | 30 | vary | 90 | 365 | 548 |
| (days) | | | | | | | | | |

As shown in Table 1, certain weighted decaying factors may be variable.

For example, the weighted decaying factor for a social networking mention may be variable based on a sentiment associated with the mention. To illustrate, signals associated with strong sentiments (e.g., a user complaining about poor customer service) may decay more slowly than weak sentiments (e.g., a passing mention of a brand or product).

Referring to FIG. 5, a first graph 510 illustrates engagements associated with the brand based on offsite signals from federated property users that have not seen the advertisement. The first graph 510 thus represents the baseline with respect to which brand lift is calculated.

A second graph 520 illustrates the baseline curve and a second curve based on offsite/advertisement signals from users that have seen the advertisement. The shaded difference between the two curves is the digital brand lift (e.g., computed as per the above equation). A third graph 530 illustrates the improved brand awareness due to the advertisement/advertising campaign.

It should be noted that brand lift is just one example of a metric that can be computed based on received signals regarding advertisements/content items. In a particular embodiment, received signals can be used to compute three metrics—engagement, brand lift, and context. Additional examples of metrics for content items include, but are not limited to, reader quality and author score.

“Engagements” may occur on-property or off-property. When an engagement occurs on-property, the described measurement system may attribute the resulting engagement signals to anonymous users, registered users, or socially registered users. Anonymous users may subsequently become registered or socially registered, and past signals collected while the users were anonymous may be carried forward for the registered or socially registered users. When an engagement occurs off-property, the measurement system may be able to correlate such actions with a user that is registered or socially registered with a property. Engagement signals from both on-property and off-property events may be received and used to calculate an engagement metric for various segments. As described above, engagement signals may vary in weight and may decay over time. In a particular embodiment, the engagement metric for a segment (e.g., a brand segment) is equal to or based on the sum of the constituent engagement signals after the signals are multiplied with the corresponding weighted decaying factors. In a particular embodiment, engagement signals may be used to calculate digital brand lift (DBL), as described above.

In certain cases, a comparison of two or more segments results in a context metric. For example, the traits of an advertisement segment, a campaign segment, or a brand segment may be compared with the traits of a property segment or a user within the property segment. The amount of overlap between the traits may be used to generate the context metric, which may be a numerical value indicating the amount of overlap or correlation. The context metric may be used to predict higher engagement, and may thus be used to predict higher brand lift. Property owners may be able to use the context metric to charge more money for higher (e.g., more successful or likely to be successful) contexts, may be more likely to achieve an advertiser's goal when optimizing for a context, and may be more likely to receive repeat business from the advertiser. In a particular embodiment, information regarding the context metric may be provided to advertisements/content items (or web servers or applications associated therewith) for use in modification of the advertisements/content items.

Thus, when an advertisement segment (served, viewed, engaged, met goal) is compared to another segment, the comparison may generate a context metric indicating if the associated advertisement is a good match for the other segment. The context metric may assist publishers and advertisement delivery systems in determining where to place the advertisement. Publishers may be able to charge increased fees for such advertisements.

As another example, when a campaign segment (served, viewed, engaged, met goal) is compared to another segment, the comparison may generate a context metric indicating if the advertisements in the associated campaign are a good match for the other segment. The context metric may assist publishers and advertisement delivery systems in determining where to place the campaign advertisements. Publishers may be able to charge increased fees for such campaign advertisements.

As another example, when a brand segment is compared to another segment (e.g., a property segment), the comparison may generate a context metric indicating if the brand is a good match around which to create an advertisement or an advertisement campaign for the other segment (e.g., on the property).

As another example, when an advertisement segment or campaign segment is compared to an individual user, the resulting context metric can be used to determine whether and how to serve the advertisement or campaign to the user.

It will thus be appreciated that the described context metric may be used on a property, within a group of properties associated with a federated property, and within a network (e.g., opt-in network) of unrelated properties to assist in advertisement placement onto segments and individual users. The context metric may also be used to predict engagement and brand lift of a particular advertisement or campaign.

For example, whether a campaign/advertisement has a high context metric when compared to a property's overall audience can be used to determine if the campaign/advertisement should be shown on the property.

As another example, whether a campaign/advertisement has a high context metric when compared to a particular content item can be used to determine if the campaign/advertisement should be shown alongside the content item.

As another example, whether a campaign/advertisement has a high context metric when compared to a particular author (or other field of content item metadata) can be used to determine if the campaign/advertisement should be shown alongside content items by the author.

As another example, whether a campaign/advertisement has a high context metric when compared to a behavioral segment can be used to determine if the campaign/advertisement should be shown in conjunction with the corresponding behavior. To illustrate, if users that visit the sports pages of a property have a high context metric with respect to users engaging with an advertisement, the advertisement may be placed on the sports section of the property.

As another example, whether a campaign/advertisement has a high context metric when compared to an individual user can be used to determine if the campaign/advertisement should be shown to the user and how the campaign/advertisement can be modified to better target the user. For example, an advertisement or content item may self-modify to be displayed on a first media property of a client instead of (or in addition to) a second media property of the client based on audience match and the audience an advertiser or publisher has targeted. As another example, an advertisement or content item may self-modify to change copy (e.g., text) based on content that an audience is determined to prefer (e.g., have high affinity for). As another example, an advertisement or content item may self-modify to adjust a color scheme based on audience characteristics (e.g., age, gender, etc.). As another example, an advertisement or content item may self-modify to display photos instead of videos for audiences that spend less time consuming content. As another example, an advertisement or content item may self-modify to include “share” buttons for socially active audiences and/or include specific share buttons for specific social networks based on which social networks are determined as being most active.

As additional examples, the context metric may be used to determine whether a campaign/advertisement is correlated with specific advertising rates of a property's advertising rate card or with specific sections of a property.

Whereas FIGS. 4-5 illustrate brand lift based on signals received within a single federated property, FIGS. 6-7 illustrate computation of brand lift based on signals received within a measurement universe, which may include multiple federated properties as well as unrelated properties. Thus, in contrast to FIGS. 4-5, in FIG. 6 the offsite signals received from the socially registered user of property 3 are available for use in determining the baseline graph 610, and are therefore not illustrated in strikethrough.

It is noted that the “intelligent ad signal” from the socially registered user of property 3 remains illustrated in strikethrough in FIG. 6. This is because such signals may not be enabled to “cross silos” of different federated properties, such as for security or privacy reasons. FIGS. 8-9 differ from FIGS. 6-7 in that the “intelligent ad signal” from the user of property 3 is available to determine brand lift. For example, the “intelligent ad signal” may “cross silos” if the federated property and the unrelated property are members of an opt-in network. Advertising campaigns may be measured across all properties that are part of the opt-in network. Thus, providing an opt-in network (which may be equivalent to the “measurement universe” at the top of the hierarchy in FIGS. 4, 6, and 8) may enable cross-property measurement of brand lift, including evaluating brand lift based on signals from otherwise unrelated properties.

It should be noted that although FIGS. 4-9 are described with reference to the measurement of advertisements, this is for example only. The described techniques may also support measurement of content to determine brand lift and/or other content-related metrics.

The described techniques may thus enable measurement of brand lift and other advertisement/content-related metrics across multiple properties and/or applications without subjecting users to cumbersome surveys. Alternately, survey data may be used as one type of input signal during computation of the described metrics. It should be noted that survey-based methodologies may be unable to account for advertising campaigns and events that outside of the survey's purview. To illustrate, consider a survey to measure brand lift due to a campaign for a particular car on a particular blog. The survey is not able to capture information from other campaigns that the car manufacturer is running on other blogs. Even if there is brand lift, it may be inaccurate to conclude that the brand lift is due solely due to the surveyed blog. In contrast, because the described techniques take into account offsite signals as well as signals from related and unrelated properties, a more complete, more accurate, and less biased picture of brand lift may be presented.

Further, when advertising campaigns for competing products or brands are tracked and combined with user profile information, advertisers may be provided with advanced information, such as whether and how much an advertising campaign for product A resulted in digital brand lift in people who have an affinity for competing product B. To illustrate, as described with reference to FIG. 1, the described advertisement measurement and modification system may maintain a brand database. The brand database may include millions of brands. Thus, the measurement system may track brand effectiveness of an advertisement for an audience that has signals (e.g., an affinity) to the brand before viewing the advertisement. Further, the system may track brand effectiveness for audiences that do not have signals to the brand or have signals to a competing brand. It will be appreciated that awareness shifts do not occur in a vacuum, and are instead contextually informed by an audience's previous likes and dislikes, demographics, geography, and social profile. Unlike survey-based techniques, the described signal-based techniques, which involve considering offsite and advertisement signals during pre-campaign, in-campaign, and post-campaign periods, may take such factors into account when determining (e.g., extrapolating) brand lift on a per-advertisement basis, per-campaign basis, per-property basis, per-federated property basis, etc.

Various advertisement/content statistics may be reported (e.g., in documents, in web pages, and/or on the overlay interface of FIG. 12). Examples of advertisement/content statistics, on a per-advertisement basis, per-campaign basis per-brand basis, per-context basis, per-platform basis, per-advertisement placement basis, per-content item basis, etc., include total and per-hour unique viewers and impressions, total and per-hour desktop/mobile/tablet users, and demographic data (e.g., household income, age, home value, gender, marital status, homeowner status, parental status, education, etc.).

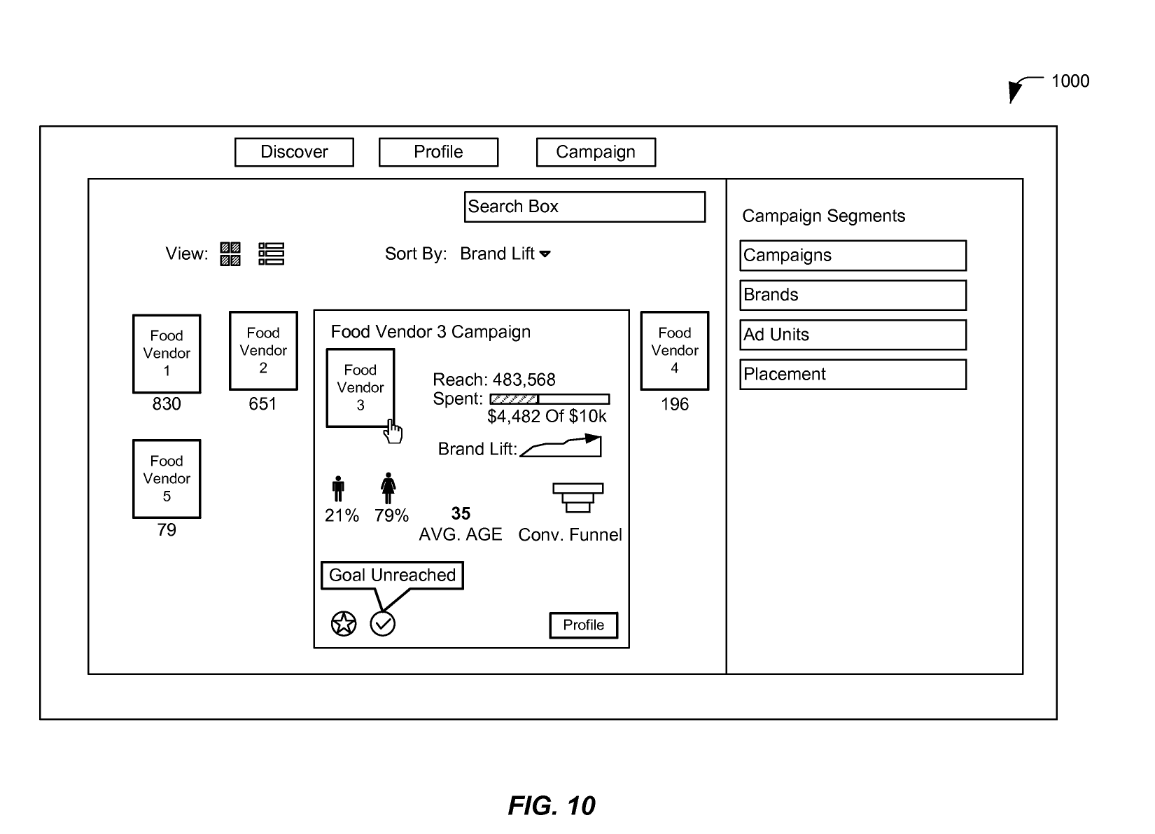

FIG. 10 is a screenshot to illustrate a particular embodiment of a grid report that includes multiple advertising campaigns and is generally designated 1000. A user may view statistics for different campaigns by hovering a mouse pointer or clicking on logos corresponding to the different campaigns. In FIG. 10, “Food Vendor 3” is selected and overall statistics for advertising campaign(s) for Food Vendor 3 are shown. The campaign(s) have a reach of 483,568 users and $4,482 of the $10,000 campaign budget has been spent. A graph illustrates brand lift achieved by the campaign(s). 21% of the audience is male, 79% is female, and the average age of an audience member is 35. As shown in FIG. 10 along the right hand side of the report, segmented reports that include values for the above metrics (or fewer, additional, and/or different metrics) may be generated per-campaign, per-brand, per-advertisement unit, per-advertisement placement, per-context, per-advertisement placement, per-platform, etc. Segmentation based on other information sent by intelligent advertisements may also be performed (e.g., context-based segmentation, platform-based segmentation, etc.).

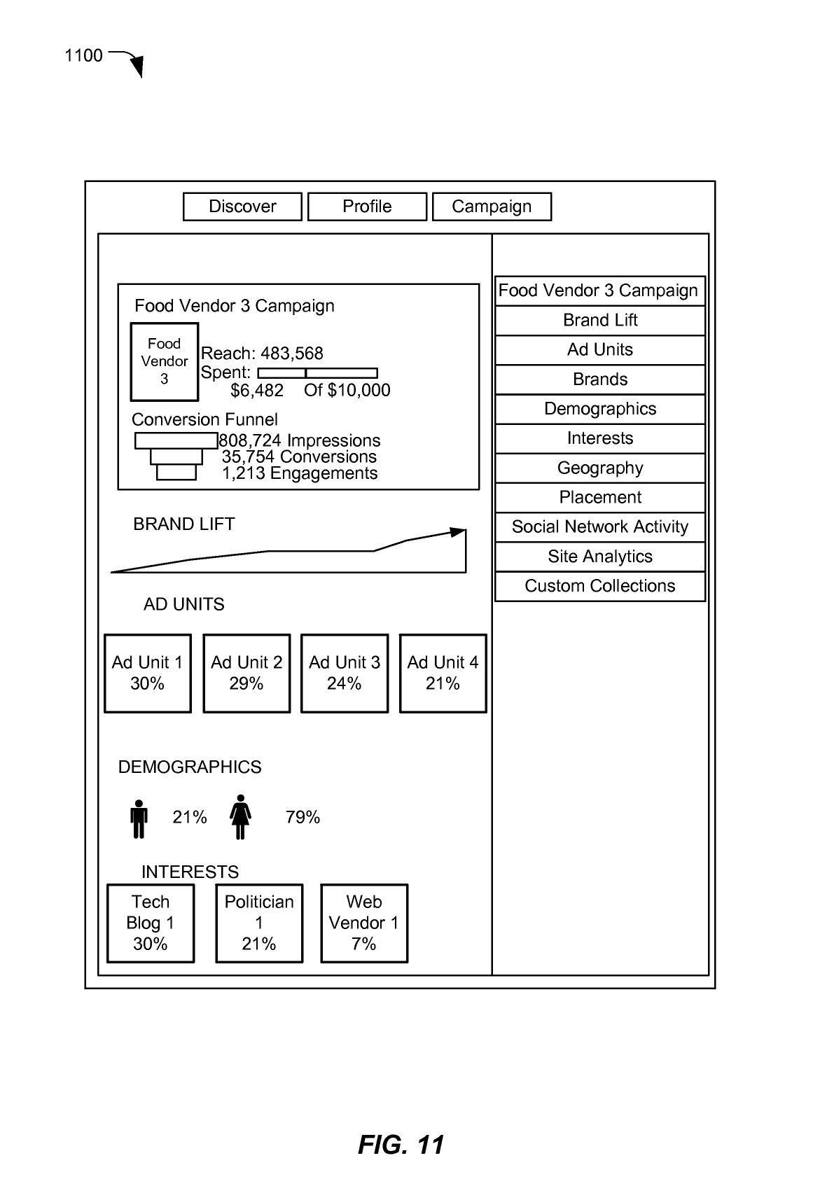

FIG. 11 is a screenshot to illustrate a particular embodiment of a list report (e.g., a drill-down view) of the Food Vendor 3 campaign selected in FIG. 10, and is generally designated 1100. As shown in FIG. 11, the report may include a graph that depicts brand lift for the Food Vendor 3 brand. The report may also include statistics for individual advertisement units (e.g., individual advertisements), demographic information of the campaign audience, and interests (e.g., affinities) of the campaign audience (e.g., as determined based on external signals regarding the campaign audience received from social networks, etc.). FIG. 11 thus corresponds to a campaign segment report. If a user clicks on a particular interest (e.g., brand) in the report, a brand segment report may be shown. On the brand segment report, information regarding various advertising campaigns and advertisements associated with the brand may be presented.

FIG. 12 is a screenshot to illustrate a particular embodiment of an overlay interface and is generally designated 1200. As shown in FIG. 12, advertisement campaign statistics may be overlaid on top of a property. Thus, a client may be able to correlate advertisement campaign statistics with the underlying web pages and advertisements that contributed to the statistics.

It should be noted that screenshots described with reference to FIGS. 10-12 are to be considered illustrative and not limiting. Generally, the systems described herein may make advertisement measurement data available to advertisers, publishers, and/or clients on different types of devices at any time via reporting interfaces, API-based access, overlay interfaces, other methods, or any combination thereof Moreover, it should be understood that although FIGS. 10-12 illustrate screenshots of advertisement-related interfaces, similar interfaces may be used to present content-related data and segments.

It will be appreciated that the described techniques may also be used to implement prediction systems for advertising and content. For example, data regarding the context, placement, brand, etc. associated with an advertisement or content item may be used, before the advertisement or content item is published, to predict the performance of the advertisement or content item once published. To illustrate, an advertisement may be scheduled for publication on a certain web page of a certain property. The measurement system may have data (e.g., a set of traits) regarding the audience of the web page and/or property, as well as data regarding how similar advertisements have performed in similar placements and contexts. Based on the data, the measurement system may be able to predict how well the scheduled advertisement will perform. In a particular embodiment, if the predicted performance does not meet campaign goals, the measurement system may suggest modifications to the advertisement, placement, context, etc. to improve performance.

In accordance with various embodiments of the present disclosure, the methods, functions, and modules described herein may be implemented by software programs executable by a computer system. Further, in an exemplary embodiment, implementations can include distributed processing, component/object distributed processing, and parallel processing. Alternatively, virtual computer system processing can be constructed to implement one or more of the methods or functionality as described herein.

Particular embodiments can be implemented using a computer system executing a set of instructions that cause the computer system to perform any one or more of the methods or computer-based functions disclosed herein. A computer system may include a laptop computer, a desktop computer, a mobile phone, a tablet computer, a set-top box, a media player, or any combination thereof. The computer system may be connected, e.g., using a network, to other computer systems or peripheral devices. For example, the computer system or components thereof can include or be included within any one or more of the devices 112-116 of FIG. 1, the CDN 122, of FIG. 1, the properties 132-134 of FIG. 1, the measurement system 140 of FIG. 1, the third party data sources 150 of FIG. 1, the measurement system 200 of FIGS. 2-3, or any combination thereof. In a networked deployment, the computer system may operate in the capacity of a server or as a client user computer in a server-client user network environment, or as a peer computer system in a peer-to-peer (or distributed) network environment. The term “system” can include any collection of systems or sub-systems that individually or jointly execute a set, or multiple sets, of instructions to perform one or more computer functions.

In a particular embodiment, the instructions can be embodied in a non-transitory computer-readable or processor-readable medium or device. The terms “computer-readable medium” and “processor-readable medium” include a single medium or multiple media, such as a centralized or distributed database, and/or associated caches and servers that store one or more sets of instructions. The terms “computer-readable medium” and “processor-readable medium” also include any medium that is capable of storing a set of instructions for execution by a processor or that cause a computer system to perform any one or more of the methods or operations disclosed herein. A computer-readable (or processor-readable) medium or device is not a signal.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the true scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method comprising:
receiving, at a measurement server, an advertisement signal from a client device, wherein the advertisement signal is associated with an advertisement presented by the client device, wherein the advertisement signal identifies profile information associated with a user, and wherein the advertisement signal identifies an event associated with presentation of the advertisement to the user;
identifying a brand associated with the advertisement; and
determining a brand lift associated with the brand based on the received advertisement signal.

2. The method of claim 1, wherein the client device comprises a web server.

3. The method of claim 1, wherein the client device comprises a desktop computing device, a laptop computing device, a mobile phone, a tablet computing device, a radio-frequency identification (RFID)-enabled device, a personal area network device, a short-range network device, or any combination thereof.

4. The method of claim 1, wherein the event comprises an impression, a view, a goal-related event, or an engagement.

5. The method of claim 1, wherein the event comprises an engagement, wherein the engagement comprises a click, a social networking action, a radio-frequency identification (RFID) signal, or any combination thereof.

6. The method of claim 1, wherein the advertisement signal includes a user profile identifier, a brand identifier, an advertisement identifier, a campaign identifier, a platform identifier, a context of the advertisement, a placement of the advertisement, a tracking code, a referring web page, or any combination thereof.

7. The method of claim 1, wherein determining the brand lift comprises determining a difference between:
a number of first signals, associated with the brand, from users who have been presented the advertisement, wherein the first signals include onsite signals, offsite signals, pre-campaign signals, in-campaign signals, post-campaign signals, or any combination thereof; and
a number of second signals, associated with the brand, from users who have not been presented the advertisement, wherein the second signals include onsite signals, offsite signals, pre-campaign signals, in-campaign signals, post-campaign signals, or any combination thereof.

8. The method of claim 7, wherein weighted decaying factors are applied to at least a subset of the signals used to determine the brand lift.

9. The method of claim 8, wherein at least one of the weighted decaying factors is associated with a maximum factor weight, a minimum factor weight, a decay period, or any combination thereof.

10. The method of claim 9, wherein the decay period is variable.

11. The method of claim 1, further comprising transmitting advertisement metric information to the client device to enable modification of the advertisement or deployment of a second advertisement based on the advertisement metric information.

12. A method comprising:
receiving, at a measurement server, a content signal from a client device, wherein the content signal is associated with a content item presented by the client device, wherein the content signal identifies profile information associated with a user, and wherein the content signal identifies an event associated with presentation of the content item to the user;
identifying a brand associated with the content item; and
determining a brand lift associated with the brand based on the received content signal.

13. A method comprising:
detecting, at a client device comprising a processor, an event associated with an advertisement presented by the client device;
sending, from the client device to a measurement server, an advertisement measurement signal associated with the detected event;
receiving, from the measurement server, information regarding performance of the advertisement; and
initiating at least one action with respect to the advertisement in response to the information.

14. The method of claim 13, wherein the at least one action comprises relocating the advertisement from a first location of a web page or an application to a second location of the web page or the application.

15. The method of claim 13, wherein the at least one action comprises presenting the advertisement on an additional web page.

16. The method of claim 13, wherein the at least one action comprises modifying text content, audio content, video content, graphics content, or any combination thereof presented in association with the advertisement.

17. The method of claim 13, wherein the at least one action comprises modifying an audience of the advertisement.

18. The method of claim 13, wherein the information comprises information regarding performance of the advertisement with respect to an advertisement campaign goal, wherein the advertising campaign goal comprises a unique impressions goal, a views goals, a frequency goal, a conversion goal, or any combination thereof

19. A method comprising:
detecting, at a client device comprising a processor, an event associated with a content item presented by the client device;
sending, from the client device to a measurement server, a content measurement signal associated with the detected event;
receiving, from the measurement server, information regarding performance of the content item; and
initiating at least one action with respect to the content item in response to the information.

20. The method of claim 19, wherein the content item comprises text content, audio content, video content, graphics content, or any combination thereof, and wherein the at least one action comprises:
relocating the content item from a first location of a web page or an application to a second location of the web page or the application;
presenting the content item on an additional web page;
modifying the text content, the audio content, the video content, the graphics content, or any combination thereof;
modifying an audience of the content item;
or any combination thereof.
